(19) United States
(12) Patent Application Publication
(10) Pub. No.: US 2006/0030210 A1
(43) Pub. Date: Feb. 9, 2006

(54) Sealed cartridge electrical interconnect

(76) Inventors: Steven Lee Willing, Encinitas, CA (US); Larry Utt, Mishawaka, IN (US); Kent Carlson, Allentown, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 11/053,579

(22) Filed: Feb. 8, 2005

Related U.S. Application Data
(60) Provisional application No. 60/543,426, filed on Feb. 9, 2004.

(51) Int. Cl. H01R 13/58

(52) U.S. Cl. 439/606

(57) ABSTRACT

A sealed cover and plastic cartridge combination for electrical connections providing sealing, strain relief, mechanical retention, electrical insulation and flex relief similar to that achieved using an over-molded design includes a plastic cartridge of integral construction or composed of two or more parts, in either case housing one or more contacts of the connections.

### CROSS-REFERENCE TO RELATED PATENT APPLICATION

This patent application claims the benefit under 35 USC 119 and 120 of the filing date and priority of provisional U.S. patent application Ser. No. 60/543,426, filed 9 Feb. 2004.

### BACKGROUND OF THE INVENTION—DESCRIPTION OF THE PRIOR ART

A typical over molded electrical cable assembly uses a three step process. First, the wire is soldered or crimped to the contact(s). Second, the wire and contact sub assembly goes through a molding process known as a “pre-mold”. This typically uses a rigid material, usually a thermoplastic such as nylon, to encapsulate the wire and rear portion of contacts. This provides mechanical reinforcement for the contacts and wires, provides electrical insulation, and positions the wires and contacts. Third, the thermoplastic assembly goes through an additional molding process, known as the “over-mold”, where a flexible material, such as vinyl nitrile or PVC, is molded over the thermoplastic and wire assembly. This step adds further encapsulation, flex and strain relief, tamper resistance, and in some cases resistance to fluids.

FIG. 1 is a schematic representation of a typical over-molded electrical cable according to the prior art.

Over molding is a cost effective technology for high volume production. For low and medium volume production it is less attractive for the following reasons. First, the cables can not be easily reworked. Second, over molding requires mold tools and mold presses. These costs can be prohibitive for smaller volume cable assemblies. Third, over molded cables have to be factory assembled. This can add costs and delays.

### BRIEF DESCRIPTION OF THE DRAWINGS

FIG. 1 is a schematic representation of a typical over-molded electrical cable according to the prior art.

FIG. 2 is an exploded isometric view illustrating a sealed cover and plastic cartridge package in accordance with the preferred embodiment of the invention.

FIG. 3 is a broken isometric view of the interior of a portion of a sealed cover part of the invention.

FIG. 4 is a broken isometric view of the interior of a sealed cover part of the invention together with a plastic cartridge shown therein.

FIG. 5 is a front elevation of the cartridge illustrated in FIG. 4.

FIGS. 6, 7 and 8 are sequential schematic elevation views of wires being connected to contacts and covered with an over-mold in accordance with the invention.

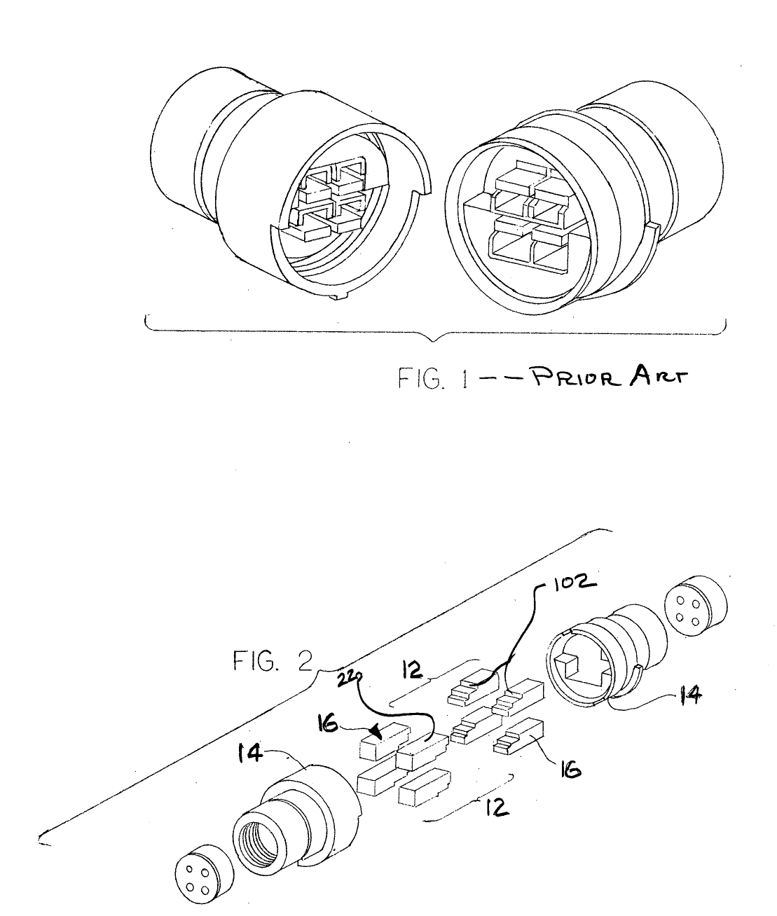

### DESCRIPTION OF THE INVENTION

This invention eliminates the aforementioned problems associated with over-molded electrical connectors. A plastic cartridge 16 made of a material such as nylon or polycarbonate that can accept one or more electrical contacts 102 is molded using standard thermoplastic molding technology. This cartridge 16 positions and retains the contacts 102; it replaces the pre-mold. A second component, the sealed cover 14, made from a softer material such as silicone or vinyl nitrile, is molded using established rubber molding technology. After molding the sealed cover is inserted over the plastic cartridge block 12 embracing plastic cartridge 16 by expanding the sealed cover 14 using a tool or fixture. The sealed cover 14 replaces the need for the over-mold.

The invention duplicates the over molding process with parts that can be manufactured independently and assembled in small quantities. This provides an advantage since the components can be manufactured and stocked in advance and then assembled to order. The assembled connectors can also be reworked.

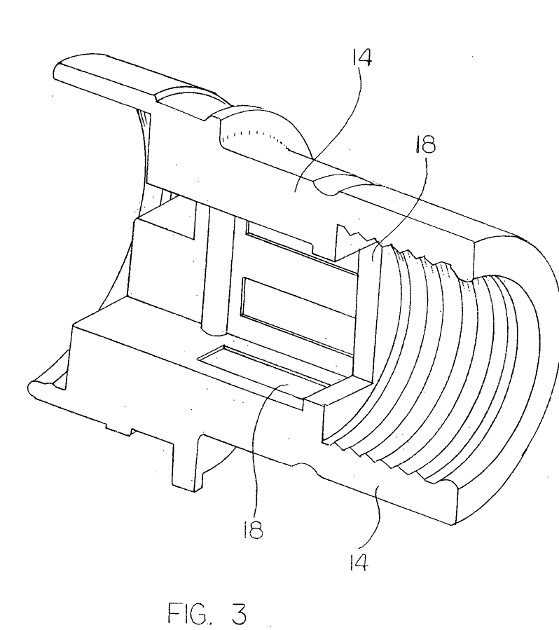

FIG. 2 illustrates a sealed cover 14 and a plastic cartridge block 12 in accordance with the invention. The block is preferably composed of four individual plastic cartridges 16 bonded together. Two sets of blocks 12 are preferably used to make the electrical connection.

As illustrated in FIG. 3, the sealed cover 14 uses alignment features on the cartridges 16 to provide mechanical strength to secure the sealed cover on to the plastic cartridge block 12. Features molded into the inside surface 18 of the sealed cover 14 match features on the outer surface 22 of the plastic cartridge block 12. This alignment enables the parts to prevent fluids from entering the electrical connection and provides sufficient mechanical strength to prevent the parts from separating under normal use. The thickness of the sealed cover 14 and the hardness of the material used are important for optimal operation. Sealed cover 14 expands to fit over plastic cartridge block 12. There is a design balance to ensure that sealed cover 14 can be expanded without tearing or stretching on the one hand, but the material must be firm enough to properly cover the plastic cartridge block 12 and remain in place.

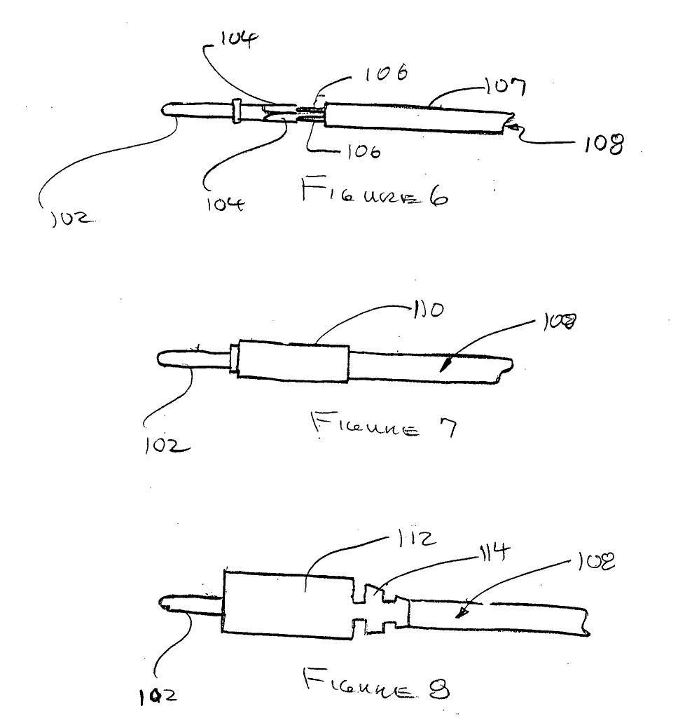

Referring to FIGS. 6, 7 and 8, FIG. 6 illustrates a contact 102 having a pair of crimpable receivers 104 extending from one end thereof where crimpable receivers 104 are aligned to receive respective wire strands 106 extending out of an insulated jacket portion 107 of an insulated wire 108. Once wire strands 106 are positioned within crimpable receivers 104, receivers 104 are crimped about wire strands 106 to mechanically retain wire strands 106 and to effectuate good electrical conductivity as between wire strands 106 and respective crimpable receivers 104.

After such crimping has been performed, a premold 110 is moved axially along insulated wire 108 into position over the now crimped crimpable receivers 104 holding wire strands 106 there-within. Finally, an overmold 112 is positioned around premold 110, as illustrated in FIG. 8, at the same axial position respecting insulated wire 108. Overmold 112 includes a flexible stress/strained relief member 114 integrally molded as a part of overmold 112. The flexible stress/strained relief member 114 provides flexible relief with respect to the electrical connection maintained by crimpable receivers 104 being crimped about wire strands 106.

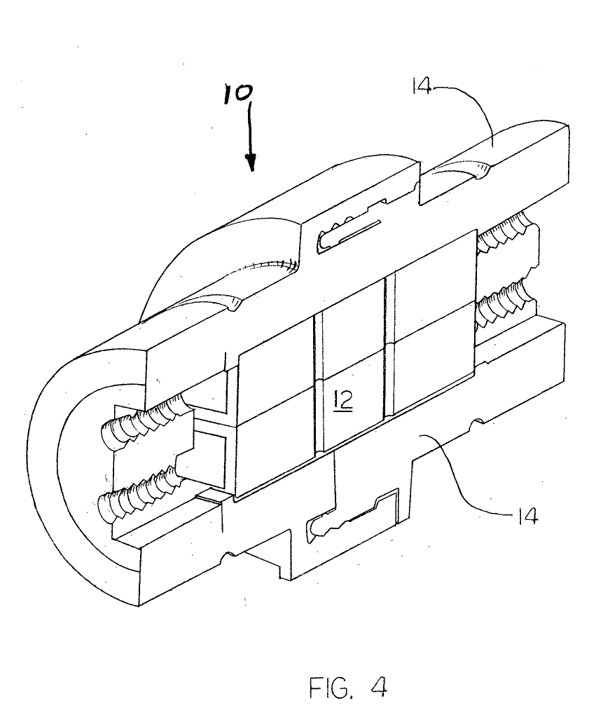

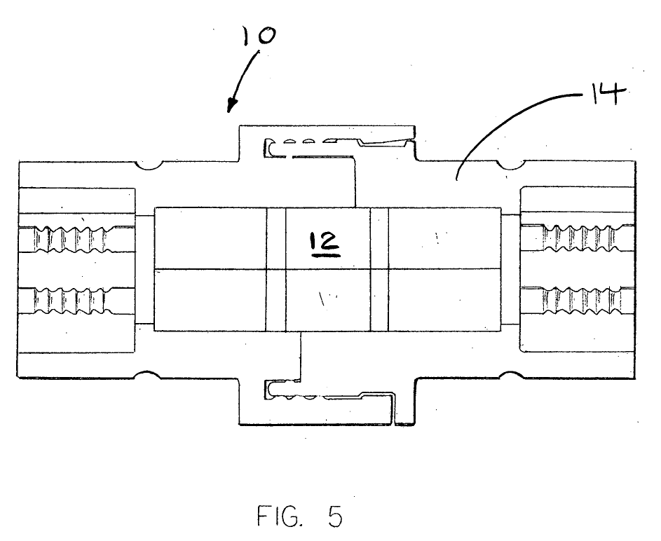

As illustrated in FIG. 4, the complete electrical connector is made by combining the contact 102, the plastic cartridge block 12 and the sealed cover 14. A connection has two sides. One side of the connection is called the “plug” and the other is called the “receptacle”. The plug and receptacle have interlocking halves that provide sealing against fluids and mechanical retention. The plug fits in the receptacle.

The following is claimed:

1. A sealed cover and plastic cartridge combination that provides sealing, strain relief, mechanical retention, electrical insulation and flex relief similar to that achieved using an over-molded design comprising a plastic cartridge composed of a single piece housing one or more contacts, or a plastic cartridge composed of two or more parts that fit together to form the overall cartridge.

2. A sealed cover designed for an existing plastic cartridge that provides fluid sealing between the mating halves of the connector and the rear of the connector where the wire enters the connector.

3. A sealed cover according to claim 2 including a separate boot for jacketed cable.

4. A single piece sealed cover according to claim 1 that includes rear sealing for a wire or cable with sealing for both the mating interface and the cable or wire entry into the plastic cartridge.

5. The sealed cover according to claim 4 including a separate grommet or boot added to the rear of the design to provide individual wire seals

6. The sealed cover according to claim 1 with rear body features to facilitate an over-mold, providing sealing between the plug and receptacle halves of the interconnect device, with the over-mold providing at least one of the following: flex relief for wires or a jacketed cable, strain relief for wires or a jacketed cable, sealing for the rear of the plastic cartridge, cosmetic features, and tamper resistance.

7. The sealed cover and plastic cartridge combination of claim 1 further comprising a wrap-around plastic cover to provide locking, with the plastic cover either sliding over the sealed cover or using a hinged design to wrap around the sealed cover, with the plastic cover having two parts—one to go over the plug and one to go over the receptacle, with the plastic cover having a locking mechanism providing positive locking between the plug and receptacle halves of the sealed cover.

8. The sealed cover and plastic cartridge of claim 7 in which the cartridge expands the sealed cover to allow easy insertion of the plastic cartridge.
